(19) United States
(12) Patent Application Publication
(10) Pub. No.: US 2017/0057315 A1
(43) Pub. Date: Mar. 2, 2017

(54) RIDE HEIGHT ADJUSTMENT SYSTEM FOR A MOTORCYCLE

(71) Applicant: MSPORT DESIGN PTY LTD, Strathmore (AU)

(72) Inventor: Ken Allen Rutherford, Strathmore (AU)

(21) Appl. No.: 14/842,370

(22) Filed: Sep. 1, 2015

(51) Int. Cl. B60G 15/06; B60G 17/027; B60G 17/08

(52) U.S. Cl. CPC B60G 15/061; B60G 17/08; B60G 17/0272

(57) ABSTRACT

An on-board mountable power unit, for ride-height adjustment of a “Softail” type of motorcycle, includes a pair of hydraulic actuators, each adapted to be mounted on the forward end of the rod of a piston and cylinder arrangement of a respective shock absorber of the rear suspension assembly of the motorcycle, after removal of the stub shaft extension of each rod. Each actuator is an hydraulic actuator ram having a housing, with longitudinally spaced forward and trailing ends between which is defined a chamber containing a piston movable between the ends. The piston has an elongate piston-rod that projects through an end plate at the trailing end of the housing, with a trailing end of he piston rod adapted for engagement with the forward end of the rod of the piston and cylinder arrangement of the respective shock absorber. The forward end of the housing has a forward extension, with a forward end of the extension engageable with the transverse bracket connecting the lower side members of the main frame of the motorcycle. Each actuator is able to connect the rod of the piston and cylinder arrangement of a respective shock absorber to the transverse bracket, similar to connection otherwise provided by the stub shaft extensions of the shock absorbers in the usual mounting arrangement for the rear shock absorbers of the motorcycle.

### FIELD OF THE INVENTION

This invention relates to an on-board power unit for ride-height adjustment of a motorcycle. The invention has particular application to certain of those Harley-Davidson motorcycles distinguished by the name “Softail”, although it may have application to motorcycles of other manufacturers that emulate the form of the Harley-Davidson “Softail” form of motorcycle frame.

### BACKGROUND TO THE INVENTION

There has been a long history of development for the form of motorcycle frame that characterised the modern Harley-Davidson “Softail” motorcycle. U.S. Pat. No. 1,266,800 to William S Harley, assignor to Harley-Davidson Motor Company, proposed an early form of a suspension system acting between the rear end of a motorcycle main frame and a rear fork frame on which the rear, drive wheel is mounted. The forward, lower corner of the rear frame is hinged to the main frame to enable the trailing end of the rear frame and a wheel carried at that trailing end to rise or fall relative to the main frame. The forward, upper corner of the rear frame carries a forwardly projecting plunger able to advance longitudinally within the reach bar of the main frame, against the action of a helical expansion spring, to enable the trailing end of the rear frame and the wheel to rise, while the trailing end of the frame and the wheel are able to fall against the reaction of leaf springs that act between each of the front and rear frames so the expansion spring and the leaf springs counteract each other. Apart from the provision of the helical spring, this early proposal is similar to the alternative arrangements for bicycles shown in U.S. Pat. Nos. 644,787 and 644,957, both to Williams.

Like the '800 patent to Harley, U.S. Pat. No. 1,272,399 to Douglas shows a suspension acting between the rear end of a main frame and a rear fork frame hinged at a forward, lower corner to the main frame. However, the suspension differs and the overall arrangement seems to be envisaged as more for a bicycle than for a motorcycle. A linkage system of a toggle link and a connecting link joins the forward, upper end of the rear frame to the main frame, while coil springs able to act in both tension and compression extend between the main frame and the toggle links.

U.S. Pat. No. 1,576,216 to Philips shows a further arrangement for a forked, rear frame hinged at a lower forward corner to the main frame, but with the suspension acting between the main and rear frames. The suspension comprises a leaf spring that extends from the rear frame to the front fork of the main frame, within a downwardly open top longitudinal channel of the main frame in which the leaf spring is secured.

U.S. Pat. No. 3,877,539 to Tilkens, assignor to Yamaha Hatsudoki KK, proposes a motorcycle shock absorbing rear fork suspension similar to that of the '800 patent to Harley. However, the Tilkens suspension utilises a helical spring to counteract with a telescopic device within and along the tank rail forming the reach rail of the main frame.

U.S. Pat. Nos. 4,022,484 and 4,087,109, both to William F Davis, are directed to overcoming what was seen as a disadvantage of previous arrangements, such as those of the '800 patent to Harley, the '399 patent to Douglas, the '216 patent to Phillips and the '539 patent to Tilkens. The disadvantage was the loss of the streamline appearance of the original rigid unitary frame that converged from a high, front end to the rear wheel axle, despite that being the appearance of motorcycles that were without rear wheel suspension. The proposal of Davis patents was to revert to the streamline appearance for the overall combination of a main frame and a rear fork frame, but also to raise the hinge connection between these frames to a level somewhat midway between the lower and upper forward corners of the rear frame, and to provide a spring/shock absorber device between the main and rear frames. In the earlier arrangement of the '484 patent, that device was coupled to the upper forward corner of the rear frame and a mid-height location at the rear of the main frame. In the '109 patent, the device was coupled to each of the upper forward corner of the rear frame and an upper rear corner of the main frame.

U.S. Pat. No. 4,568,101 to Bleustein et al., assignors to Harley-Davidson Motor Co., Inc., provides an automatic suspension system for vehicle, such as a motorcycle, that enables adjustment of the front and rear suspension systems. The automatic system is not of overall relevance to the present consideration as, in the context of motorcycles, it essentially relates to a single frame in relation to which the front and rear suspension systems are mounted. However, the '101 patent has an informative description of motorcycle height criteria.

With the advent of the Harley-Davidson “Softail”, there then followed a number of proposals for modification of its performance. One of the first of these proposals was that of U.S. Pat. No. 5,348,112 to Vaillancourt, assignor to Works Performance Products, Inc., which proposes a motorcycle height adjuster indicated as suitable for suspensions of the kind distinguished by the name “Softail” popularised by Harley-Davidson Motor Co. Inc. The proposal is indicated as enabling “on-the-go” adjustment from the rider's position. The height adjuster has a manually operable double-acting control unit by which hydraulic fluid is supplied to or withdrawn from a spring biased piston and cylinder actuator, via an hydraulic line extending between the control unit and the actuator. The control unit can be positioned at a convenient location on a motorcycle, with the actuator having its cylinder and a rod of the piston coupled to a respective one of the main frame and rear fork frame of the motorcycle. The actuator may be positioned in a parallel relationship to a similarly coupled shock absorber such that, as the actuator is extended, a spring of the shock absorber is compressed

U.S. Pat. No. 5,487,443 to Thurm proposes removal of the system of a swing axle tube and parallel shock absorbers of a Harley-Davidson “Softail” motorcycle, and replacement of the system by a torsion bar having a longitudinal axis coincident with the pivot axis on which the rear fork frame is adjustable relative to the main frame.

U.S. Pat. No. 6,003,628 to Jurrens et al. suggests needs for maintaining the aesthetic appearance of the “Softail” frame while improving ride and comfort and for enabling the rear to be raises or lowered when desired. To fulfil these needs there is provided an arrangement in which the parallel shock absorbers of a Harley-Davidson “Softail” motorcycle are replaced by air bags operating through a housing of two relatively slidable housing parts. However for a motorcycle suited for use over rough terrain, the arrangement of the '628 patent is indicated as needing to be of an embodiment also including an in-line shock absorber.

U.S. Pat. No. 6,123,165 to Smith, assignor to Chrome Specialties, Inc., provides a swing arm adjuster for a “Softail” motorcycle frame having the usual dampers or shock absorbers. The adjuster has a mounting bracket for a damper that is connected to a threaded receiver and an adjuster plate that is connected to the swing arm of the rear frame, with a threaded nut through the adjuster bracket. The adjuster is able to adjust the connection to the damper and also the steady state position of the rear frame relative the main frame at a selected ride height.

U.S. Pat. No. 6,131,494 to Quenneville describes the inter-relationship between the rear fork frame and the main frame of a Harley-Davidson motorcycle, and shows in FIG. 1 what is identified as from a Harley-Davidson 1999 owner's manual. However, the '494 patent is of limited further relevance in detailing only a shock absorber adjustment tool.

U.S. Pat. No. 6,142,498 also to Smith, assignor to Chrome Specialties, Inc., identifies the '484 patent to Davis as showing a typical frame for Harley-Davidson “Softail” motorcycles, at least through to about December 1998. The '498 patent utilises the same basic front and rear frames as the '165 patent, but specifies a narrower spacing between the upright frame members at the rear of the main frame and the forward end of the rear fork frame such that the drive belt, chain or other drive member can be outside the upright members, avoiding the need to remove the rear frame for replacing the drive.

U.S. Pat. No. 6,193,005 to Jurrens relates to the same arrangement as provided in the '628 patent to Jurrens et al., but also adds an alternative form of that arrangement. The alternative form provides more positive guidance for longitudinal movement between the relatively slidable housing parts, with incorporation of resilient stops. Also, hydraulic or pneumatic damping of travel of the air bags.

Successful, but abandoned, US patent application 2002/0066611 by Lane et al., parallels the '443 patent to Thurm, the '628 patent to Jurrens et al. and the '005 patent to Jurrens, in pointing to limitations in the ride comfort provided by the Harley-Davidson “Softail”. The approach of the '628 patent is criticised, in part because the air-bag is difficult to retrofit and more expensive. However, in addition to an alternative engine mounting arrangement, Lane et al. then proceeds to propose significant changes to detail of the “Softail” frame structure that amounts to an alternative design, as distinct from something enabling a retrofit, to enable installation of an air suspension system comprising an air bag between the rear of the front frame and the rear frame.

U.S. Pat. No. 6,357,546 to Crosby, Jr., points to limitations with the air-bag arrangement of the '628 patent to Jurrens et al., and proposes an alternative to the air-bag arrangement of the '661 patent application by Lane et al.

U.S. Pat. No. 6,905,126 to Jurrens adapts an air bag suspension for “Softail” motorcycles for motorcycles of other types, such as the Harley-Davidson “FL” models. As in proposals for the “Softail”, the original pair of hydraulic shock absorbers, each mounted between a respective fender strut and a respective swing arm, are replaced by air bags. An on-board compressor and a solenoid co-operate through an air distribution system to supply air to the air bags, with the compressor and solenoid selectively operable electrically by three-position a switch

U.S. Pat. Nos. 7,798,295 and 8,307,963, each to Jurrens and relating to the same proposal, restate the discussion in the '433 patent to Thurm on the constraints inherent in the “Softail” motorcycle frame system. The common proposal of the patents is an air bag suspension device that, in at least one form, incorporates and is co-axial with an hydraulic piston and cylinder assembly.

U.S. Pat. No. 8,403,092 to Trethewey proposes a further development along the lines of the '546 patent to Crosby, Jr.

The extensive work reflected in each of the '628; '005; '126; '295 and '963 U.S. Pat. Nos. to Jurrens has resulted in the “Softail” air suspension kits for pre- and post-2000 Harley-Davidson motorcycles marketed by Legend Air Suspensions, Inc. of Sturgis, S.D.

The present invention seeks to provide an alternative for achieving ride-height adjustment for motorcycles that have or emulate the form of the certain of the Harley-Davidson motorcycles distinguished by the name “Softail”, including those of manufacturers other than Harley-Davidson. The invention, in particular is directed to enabling such adjustment for post-1999 Harley-Davidson “Softail” motorcycles.

### Context of the Invention

This invention relates to an on-board power unit for ride-height adjustment of a motorcycle. The invention has application to certain of those Harley-Davidson motorcycles distinguished by the name “Softail” and, in particular, those “Softail” motorcycles manufactured in the post-1999 era. However, the invention may have application to motorcycles of other manufacturers that emulate the form in that era of the Harley-Davidson “Softail” form of motorcycle frame and rear suspension. The motorcycles in question (herein collectively referred as being of the “Softail” type of motorcycle) have a frame that includes a main frame and a rear frame that is mounted on the trailing end of the main frame and on which a rear, driven wheel is attached. The rear frame is hinged to the main frame so as to be able to rise or fall on a transverse pivot axis under the control of a rear suspension comprising a shock absorber suspension assembly acting substantially horizontally between the trailing end of a motorcycle main frame and the rear frame. The suspension assembly comprises a laterally spaced, parallel pair of hydraulically dampened shock absorbers.

The parallel pair of laterally spaced shock absorbers of the suspension assembly of the “Softail” type of motorcycle each have a trailing end pivotally connected to the lower front corner of the rear frame. Each shock absorber extends from the rear frame, across a lower transverse member secured to the rear end of each of a lower member along each side of the main frame, to a connection between the leading end of the shock absorber and a transverse bracket connecting the lower side members of the main frame. Each shock absorber has a cylindrical housing containing an hydraulically dampened piston and cylinder arrangement, with a piston rod projecting through an adjuster plate secured in the leading end of the housing to a connection, via a threaded spindle comprising an extension referred as a stub shaft, to the transverse bracket of the main frame. The trailing end of the cylinder projects through the trailing end of the housing and is pivotally connected to a lower transverse member secured to the forward end of each of a lower member along each side of the rear frame. Each shock absorber also includes a helical spring mounted around the cylinder of the piston and cylinder arrangement and contained between an annular retainer fixed around the leading end of the cylinder and an annular stop located around the trailing end of the cylinder and fixed to an annular flange at the trailing end of the housing. The arrangement is the reverse of that usual with shock absorbers in that the shock absorbers expand or contract as the rear frame pivots up or down, respectively, to cause compression or expansion of the spring, with spring recovery dampened by the piston and cylinder arrangement.

The shock absorbers of the “Softail” type of motorcycle are positioned below the seat for the rider of the motorcycle and are substantially concealed by a cover under the transmission. While the shock absorbers are functionally limited due to their positioning, this is a design feature intentionally adopted to capture the aesthetic appearance of the downwardly and rearward tapering lines of earlier rigid models that were without rear shock absorbers.

In the section of this specification headed “Context of the Invention” and in the disclosure following section on the power unit of the invention, both as described and claimed in this specification, terms indicating direction and orientation, such as leading, trailing, transverse, lateral, forward and rearward, and their grammatical variants, are to be understood as used relative to a “Softail” type of motorcycle and its forward travel in normal use.

### BROAD SUMMARY OF THE INVENTION

According to the invention, there is provided an on-board mountable power unit for ride-height adjustment of a “Softail” type of motorcycle. The unit includes a pair of hydraulic actuators, each adapted to be mounted on the forward end of the rod of a piston and cylinder arrangement of a respective shock absorber of the rear suspension assembly of the “Softail” type of motorcycle, after removal of the stub shaft extension of each rod. Each of the actuators is in the form of an hydraulic actuator ram, and has a housing that has longitudinally spaced forward and trailing ends and that defines a chamber containing a piston movable between those ends. The piston has an elongate piston-rod that projects from the trailing end of the housing, through an annular end plate fitted in the trailing end of the housing, with the piston-rod having a trailing end adapted for engagement with the forward end of the rod of the piston and cylinder arrangement of the respective shock absorber. At the forward end, the housing has a forward extension with a forward end of the extension engageable with the transverse bracket connecting the lower side members of the main frame of the motorcycle. That is, each actuator is able to connect the rod of the piston and cylinder arrangement of a respective shock absorber of the motorcycle to the transverse bracket of the main frame of the motorcycle, with this connection similar to that otherwise provided by the stub shaft extensions of the shock absorbers in the usual mounting arrangement for the rear shock absorbers of a “Softail” type of motorcycle. However, each of the shock absorbers needs first to be removed from their mountings on a “Softail” type of motorcycle and, after the stub shaft extensions are removed, each of the actuators is mounted on a respective shock absorber by the piston-rod of the actuator being threaded onto the rod of the piston and cylinder arrangement of the shock absorber, and the shock absorbers then are re-installed in an assembly including the actuators.

The housing of each actuator has a port through which pressurised hydraulic fluid can be charged to the chamber of the housing at a trailing side of the piston. The arrangement is such that hydraulic fluid can be pumped into or from the chamber to drive the piston to or towards a required or selected one of the leading and trailing ends of the chamber to attain a desired position for the piston in the chamber. Thus, with the power unit installed on a “Softail” type of motorcycle, the rod of the piston of the piston and cylinder arrangement of the shock absorber of the motorcycle can be drawn to a required position. Accordingly, the actuators are operable to adjust the shock absorbers of a “Softail” type of motorcycle to attain a required ride height, with the ride height being able to be varied, as required by a rider of the motorcycle, over a range preferably limited only be the physical constraints inherent in the hinged connection between the main and rear frames of such motorcycles. That is, the housing of each actuator is able to have a chamber enabling the piston to be movable between trailing and leading extremes that do not limit that range.

The stroke of the piston of each of the actuators in a power unit of the invention, for the typical stroke of the piston and cylinder of the shock absorber for a Harley Davidson “Softail” motorcycle, may be at least 20 mm, preferably at least 21 mm, such as 22 mm. The chamber of the housing in which the piston is movable may have a diameter that is greater than the stroke of the piston, with a suitable diameter ranging up to about 45 mm. However, the diameter may range from about 38 mm to about 42 mm. As will be appreciated, the actuator is very small relative to the shock absorber, and also in relation to alternative arrangements proposed for the “Softail” type of motorcycles although, as detailed later in this disclosure, the actuators are part of a power unit that provides new useful benefits for riders of the “Softail” type of motorcycles, in particular in relation to ride height adjustment.

In each actuator, the axial length of the housing between the leading and trailing ends and the stroke of each piston within the housing are such that, with the actuators installed on a “Softail” type of motorcycle, the actuators are able to position the shock absorber at or between first and second extreme positions spaced by the stroke of the actuator pistons. The positioning results from appropriate flow of hydraulic fluid to or from the chamber of each actuator to adjust the respective piston and, hence, the extent to which the piston-rod of each actuator projects from its housing. In the first of the extreme positions the adjuster plate at the leading end of the shock absorber housing is closely adjacent to the end plate at the trailing end of the housing of the actuator, while in the second position the adjuster plate and the end plate are axially spaced by substantially the stroke of the actuator pistons. In the first position the leading end of the piston rod of each of the shock absorbers preferably is received within the inner periphery of the end plate of the respective actuator housing, while the trailing end of the piston-rod of each actuator remains within the inner periphery of the adjuster plate of the respective shock absorber throughout positioning of the shock absorbers. With the piston of each actuator in an intermediate position between the first and second extremes, the shock absorbers are operable in response to variation to operating loadings.

The forward extension of each actuator of the power unit of the invention is short relative to the removed stub shaft extension, due to space to be occupied by the actuator housing when the power unit is installed in a motorcycle. In the Harley Davidson “Softail” motorcycles each stub shaft extension passes in turn through a bushing and a first cup washer with a fitted grommet before passing, from the trailing side, through a hole in an upright flange of the transverse bracket by which the lower side members of the main frame are connected, and the arrangement then is secured at the leading side of the flange by a second cup washer with a fitted grommet and a retaining nut threaded onto the stub shaft extension. However, with the relatively shorter forward extension on each actuator of the power unit, there is no space for such a bushing and first cup washer. Instead, a first grommet is provided on the forward extension of each actuator, against the outer surface of the leading end of the housing, with the forward extension then passing through the upright flange and being retained by a cup washer with a second grommet, and a retaining nut threaded onto the leading end of the forward extension.

In each of the actuators the piston-rod and the forward extension preferably are co-axial with each other and with the chamber in which the piston is movable, with the chamber of cylindrical form. The piston-rod may be an annular sleeve having a bore throughout the length of the sleeve. As indicated above, the trailing end of the forward extension is internally screw threaded for engagement with the leading end of the rod of the shock absorber of the motor cycle although, with a sleeve form of piston-rod, the internal threading need only be at the trailing end of the bore. Where the piston-rod is a sleeve with a through bore, the actuator may include a shaft that projects from the wall at the leading end of the housing, co-axially within the chamber and into the bore of the sleeve. Over a main part of its length, the shaft may be a neat sliding fit in at least a leading end part of the bore of the sleeve. Preferably, the shaft has a slightly larger trailing end part that is a neat sliding fit in a main part of the length of the bore of the sleeve, such that at a rearward limit to the movement of the piston in the housing, a forwardly facing annular surface of the shaft within the sleeve bears against a rearward facing annular surface of the sleeve.

For actuators having a shaft that projects co-axially within the chamber from the wall at the leading end of the housing, the forward extension also may be an annular sleeve having a bore extending throughout the length of the sleeve. Particularly in that event, the piston may be of annular form that fits neatly on the leading end of the piston-rod and secured, such as by provision of a round wire snap ring captured in opposed grooves, comprising a first groove around the piston-rod and a second groove in the inner periphery of the piston. Also in that event, the shaft may extend from within the bore of the forward extension, while it may be retained within that bore, such as by screw-threaded engagement in the bore. The shaft may have a leading end that is at, adjacent to or close to the leading end of the forward extension, such as to be accessible from the leading end of the forward extension. The arrangement may be such that, by access at that leading end, the shaft is longitudinally adjustable in the forward extension to vary, by a limited amount, the extent to which the shaft extends into the chamber. Thus where, as indicated above, the shaft and the piston-rod have oppositely facing annular surfaces that are able to abut, the rearward limit to the movement of the piston in the housing can be adjusted to a limited amount, for reasons explained later herein. However, access at the leading end of the forward extension may be, and preferably is, precluded by a safety seal.

The forward extension and the housing of the actuator, including the end wall at the leading end, preferably comprise a single-piece, unitary construction that may be produced by casting or machining of a suitable high strength metal, such as a high tensile, preferablynitrided, steel. The chamber is defined by the wall at the leading end of the housing, a peripheral wall and the annular end plate, with the end platefitted at the trailing end of the housing and the piston-rod extending through the end plate. A relatively short trailing end section of the peripheral wall accommodates the end plate. The end section has a slightly larger internal diameter than the chamber along which the piston is movable, to provide an internal shoulder of the housing against which a peripheral flange of the end wall locates. A resilient “O” ring is forced against the trailing side of the peripheral flange by a retaining circlip, to provide a static seal between the housing and the periphery of the end wall. A dynamic seal is provided between the piston-rod and an inner peripheral surface of the end plate, with this comprising an “O” ring seal located in an annular groove in the inner peripheral surface, with the seal preferably an X-section ring. A similar dynamic seal is provided between the inner periphery of the piston and the piston-rod, adjacent to the circlip that retains the piston on the piston-rod, while a further similar dynamic seal is provided between the outer periphery of the piston and the housing. The static seal, and each dynamic seal, preferably is formed of a suitable grade of a synthetic rubber, for example a Nitrile rubber such as Nitrile 70 durometer rubber. Also, the trailing face the end plate has an annular flange concentric with and closely adjacent to the piston-rod, and a wiper ring is provided between the flange and the piston-rod.

The respective port through which pressurised hydraulic fluid can be charged to the housing of each actuator communicates with an annular groove formed around the inner surface of the trailing end section of the housing on the leading side of the dynamic seal provided against the flange of the end plate. From that groove, the hydraulic fluid is able to pass to the chamber via a number of radial grooves in the internal shoulder of the housing or in an outer margin of the leading face of the end plate.

The on-board mountable power unit of the invention also includes an hydraulic power unit operable to supply pressurised hydraulic fluid to, or to enable hydraulic fluid to discharge from, the chamber of each actuator to enable adjustment of the ride height of a “Softail” type of motorcycle on which the power unit is mounted. The power includes a reservoir containing a sufficient volume of hydraulic fluid, a pump for supplying hydraulic fluid from the reservoir to the chamber of each actuator via a respective hydraulic fluid flow line and enabling a return flow of fluid to the reservoir, and an electric motor operable for driving the pump. Preferably, the power unit also includes ancillary circuitry connectable to the electric system of the motorcycle for operating and controlling the electric motor according to the requirements of the motorcycle rider.

The size, positioning and functioning of the actuators of the on-board mountable power unit are such that they can be installed and operated in substantially complete harmony with the design criteria for the “Softail” type of motorcycle. That is, the actuators do not detract from such motorcycles having the aesthetics of the rigid frame Harley Davidson motorcycles that are without rear suspension. However, the actuators provide a further benefit in that they are fully compatible with the hydraulic power unit being able to be of a preferred form in which it can be of a size and form that also can be positioned and operated in substantially complete harmony with those design criteria. Thus, in a preferred form, the reservoir, pump, hydraulic fluid flow line and electric motor of the power unit is assembled into a compact unit able to be installed and secured between the lower side members of the main frame, adjacent to the leading side of the transverse bracket that connects those side members. For this, the power unit preferably is housed in a suitable frame structure mountable in relation to the lower side members of the main frame.

In one convenient arrangement, the power unit is secured by being housed in a frame structure having an under-tray assembly, designed to be positioned under the lower side members of the main frame, and a mounting bracket assembly able to be located between those side members and secured to the under-tray assembly. The bracket assembly may consist of a leading mounting bracket and a trailing mounting bracket each of which can be connected to the under-tray such as by screw-threaded bolts. The trailing mounting bracket preferably is shaped to fit against the leading surface of the transverse bracket that connects between those lower side members, with each end of the trailing bracket shaped to fit around the retaining nut threaded onto the leading end of the forward extension of each actuator. The trailing bracket may be held in such position by having hooks that engage over the upper edge of the upright flange of the transverse bracket, with the hooks being held in engagement with that edge by threaded engagement between the trailing mounting bracket and the under-tray assembly located below the lower side members. The leading mounting bracket is spaced forwardly from the trailing mounting bracket and preferably is held by having respective end portions each engageable around a respective lower side member.

The power unit may have a compact electric motor, conveniently a 12 volt DC motor, such as one operable on a supply current of about 10 amps. The pump also may be of a compact form, and preferably comprises a bi-directional, gear type of pressure pump provided with a pressure relief valve. The reservoir may define a chamber in direct communication with an intake port of the pump. The chamber preferably has a capacity enabling it to accommodate the volume of hydraulic fluid able to be pumped from the actuators, such that the reservoir remains substantially unpressurised. In one convenient arrangement, the reservoir is in the form of a resilient, synthetic rubber housing having a mouth bordered by a peripheral out-turned flange by which the housing can be clamped against a mounting block in relation to which the motor and pump also are secured. The arrangement may be such that the reservoir communicates with the intake port of the pump through the mounting block, with the pump having an outlet port that is in communication through the mounting block with two connectors for a respective hydraulic flow line communicating with the chamber of each actuator.

With the actuators installed on a “Softail” type of motorcycle and operated to position the shock absorbers in or close to the first of the two extremes discussed, access to the adjuster plate of each shock absorber is limited. The adjuster plate is rotatable to enable the pre-loading of the shock absorbers to be adjusted, with this requiring fitting of a special adjuster tool, similar to that disclosed in the above-mentioned U.S. '494 patent to Quenneville, to locate prongs or the like in circumferentially spaced holes in the outer face of the adjuster plate. With the shock absorbers in or close to the first extreme position, the prongs are not able to be located as required due to the holes being positioned radially inwardly from the outer circumference of the adjuster plate and opposed by the actuator housing. The power unit of the invention therefore needs to be operated to move the adjuster plate to the second extreme position, although an alternative is to use the power unit in conjunction with a modified form of adjuster plate to be substituted for that present as original equipment in the shock absorbers of the “Softail” type of motorcycle. Rather than having holes located radially inwardly from the outer periphery as in the adjuster plate of those shock absorbers, one form of the modified adjuster plate has circumferentially spaced recesses formed in, and preferably opening to the outer periphery of, the modified plate, with the recesses also opening to the leading surface of the plate and having a form suited for co-operation with prongs or the like of a suitably, corresponding form of adjuster tool. The recesses may, for example be of substantially circular form as viewed from that leading surface, but opening to the outer periphery of the plate. The modified adjuster plate enables access by the corresponding form of tool, due to the recesses being accessible radially outwardly of the actuator housing.

In an alternative form, a modified adjuster plate for each shock absorber replaces the original equipment adjuster plate and is adapted to be used in combination with an internal collar device that is adapted to be fitted around the leading end of the cylinder of the piston and cylinder arrangement of the shock absorber. The modified adjuster plate has a central bore sized to enable the modified plate to be secured as a press fit on the trailing end of the piston-rod of the actuator, with the modified plate then fitted in the leading end of the shock absorber housing in a similar manner to the originally supplied replaced adjuster plate. The collar device fits around the cylinder, preferably by being received from the trailing end of the piston and cylinder arrangement, and secured on the leading end of the cylinder. The collar has inner and outer concentric parts that are coupled together by a screw-threaded engagement so that, with the inner part axially fixed on the cylinder, the outer part is able to rotate and move axially relative to the inner part. The inner part may be fixed on the cylinder in a number of suitable ways, although it preferably is releasably fixed on the cylinder. In one convenient form, the inner part has a bore through which the cylinder is received, with the bore tapered so as to as to have a slightly frusto-conical form, with half angle of about 1 or 2 degrees, that increases slightly in diameter towards the leading end. The inner part can be fixed on the cylinder by being forced axially over a wire snap ring located in a peripheral groove in the outer surface of the cylinder so the tapered bore surface bears against and compresses the snap ring into the groove. With the inner part fixed on the leading end of the cylinder of the piston and cylinder of a shock absorber, the outer part is able to rotate on the inner part so and move axially in one of opposite axial directions, depending on the direction of the rotation.

With the modified adjuster plate used with the two-part collar device, the outer part of the collar device replaces the annular retainer of the original equipment shock absorber. As with that retainer, the collar device enables variation in the degree of pre-load applied to the spring of the shock absorber, with the pre-load varied by rotation and axial adjustment of the outer part of the collar device relative to the inner part. That rotation is able to be achieved by inserting the of prongs of a suitable tool through selected openings spaced around the outer periphery of the modified adjuster plate, and engaging the prongs with formations of the outer part of the collar device. The modified adjuster may, for example, have three, four or even more uniformly spaced openings through at least two selected openings respective prongs are able to be inserted to enable the tool to apply required torque for rotating the modified adjuster plate and the outer part of the collar device. The outer part may have a circumferential array of longitudinally extending openings or keyways in selected ones of which the prongs are locatable for rotation of the outer part by the tool. In one convenient arrangement, the openings or keyways are defined by the outer periphery of the outer part being defined by a circumferential array of alternating ribs and grooves, with the grooves being U-shaped in cross-section.

In order that the invention may more readily be understood, description now is directed to the accompanying drawings, in which:

### BRIEF DESCRIPTION OF THE DRAWINGS

FIG. 1 is an exploded schematic perspective view of parts of the frame structure of a “Softail” type of motorcycle and two shock absorbers operable in parallel between the frame parts;

FIG. 2 shows an exploded perspective view of a typical shock absorber for the frame of FIG. 1;

FIGS. 3A, 3B, and 3C show three longitudinal views of the shock absorber of FIG. 2, illustrating respective operating settings;

FIG. 4 shows the rear frame geometry at various positions throughout the maximum design range of pivoting relative to the main frame;

FIG. 5 is an exploded perspective view of components of an on-board mountable power unit system of the invention;

FIG. 6 is a similar view of actuators and hydraulic power unit of the system of FIG. 5, shown in relation to part of the electrical system of a “Softail” type of motorcycle;

FIG. 7 shows a schematic representation of the power unit of the FIG. 5 in relation to the electrical system of a Harley Davidson motorcycle;

FIG. 8 is a schematic representation of the hydraulic system for the power unit of FIG. 6;

FIGS. 9A, 9B, and 9C show two perspective views (FIGS. 9A and 9B), and a plan view (FIG. 9C), each showing the unit of FIG. 6 in relation to shock absorbers and lower side frame members, and transverse connecting members, of a main frame of a “Softail” type of motorcycle;

FIGS. 10A, 10B, 10C and 10D show a perspective view (FIG. 10A) of an actuator of the power unit of FIG. 6, and sectional views (FIGS. 10B, 10C, and 10D) of the actuator in respective in-use operating conditions;

FIG. 11 corresponds to the view of FIG. 10B, but is on an enlarged scale;

FIGS. 12A, 12B, 12C and 12D show sectional views of the actuator of FIGS. 10A, 10B, 10C and 10D in respective conditions and as assembled in relation to a shock absorber, including a view (FIG. 12C) corresponding to the view of FIG. 12A but schematically showing the actuator and shock absorber connected in relation to a part of the main frame of a “Softail” type of motorcycle.

### DETAILED DESCRIPTION OF THE DRAWINGS

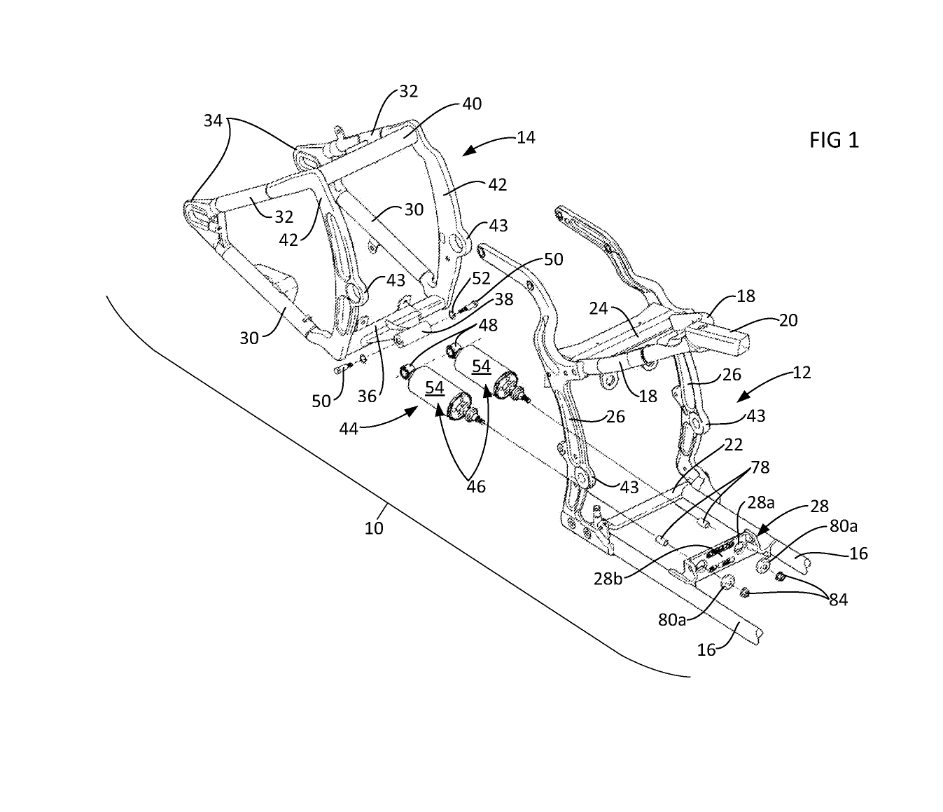

The frame structure 10 shown in FIG. 1 for a “Softail” type of motorcycle (not shown, and represented only by the frame structure 10) includes a main frame 12, of which only the trailing part is shown, and a rear frame 14 that also is referred to as a rear fork. Insofar as shown, the main frame 12, for each side of the motorcycle, has a respective lower elongate side member 16 and a respective upper elongate side member 18 all extending forwardly from the rear end of the main frame 12. The lower side members 16 are substantially horizontally disposed and parallel to each other. In contrast, the upper side member 18 are inclined forwardly and upwardly from the rear end of the main frame 12 and, at their forward ends, the members 18 are joined together and to a forwardly extending central member 20. While not shown, the forward ends of lower side members converge forwardly and upwardly to a connection with the forward end of central member 20 at which handle-bars and front wheel structure is mounted.

The lower side members 16 and the upper side members 18 are secured in a relatively rigid laterally spaced relationship by respective transverse connecting members. The connecting members include a lower transverse member 22 secured to the rear end of each lower side member 16, an upper transverse frame member 24 secured to the rear end of each upper side member 18 and, at each side of the motorcycle, an upright strut 26 that joins the rear ends of the respective lower member 16 and upper member 18. Each of the struts 26 is forwardly curved between the rear ends of the respective members 16 and 18. The lower side members 16 also are connected by a transverse bracket 28 that is spaced a short distance forwardly of the lower transverse member 22.

For each side of the motorcycle, the rear frame 14 has a respective lower side member 30 and a respective upper side member 32, with members 30 and 32 at each side of frame 14 converging to the trailing end, away from the main frame, to form a rear wheel axle mount 34. The lower and upper side members 30 and 32 of each side are secured in a relatively rigid laterally spaced relationship by connecting members that include a lower transverse member 36 secured to the forward end of each lower side member 30 and having a short, transverse tubular mount 38 centrally secured along the leading side of member 36; an upper transverse member 40 secured to the forward end of each upper member 32; and, at each side of the motorcycle, an upright strut 42 that joins the leading ends of the lower and upper members 30 and 32 and that is forwardly curved between the forward ends of the lower and upper side members 30 and 32.

The curved struts 26 of the main frame 12 and the curved struts 42 of the rear frame 14 are complementary and inter-fit, with each strut 42 of the rear frame 14 laterally adjacent to an inner surface of a respective strut 26 of the main frame 12. The arrangement is such that the struts 42 are between the struts 26, with adjacent respective struts 26 and 42 hinged together at a mid-height location of the struts 26 and 42, by aligned bushings (not shown) that are journalled in aligned bosses 43 and define a transverse pivot axis “X”(depicted in FIG. 4). The hinge connection at those locations enables the rear frame 14 to pivot relative to the main frame 12 to a limited extent whereby the trailing end of the rear frame 14, and a rear wheel (not shown), when rotatably mounted on the rear wheel axle mounts 34, can rise or fall on an arcuate path to a corresponding limited extent under the control of a rear suspension assembly 44 acting between the main and rear frames 12 and 14.

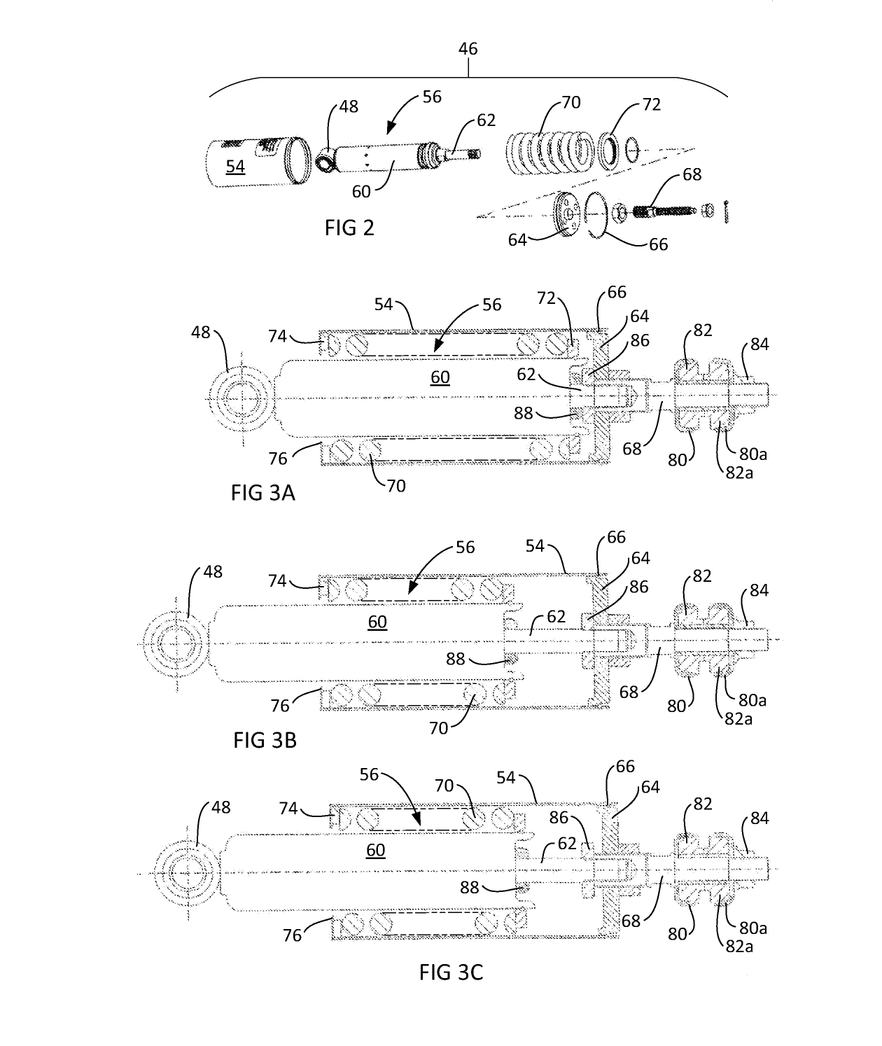

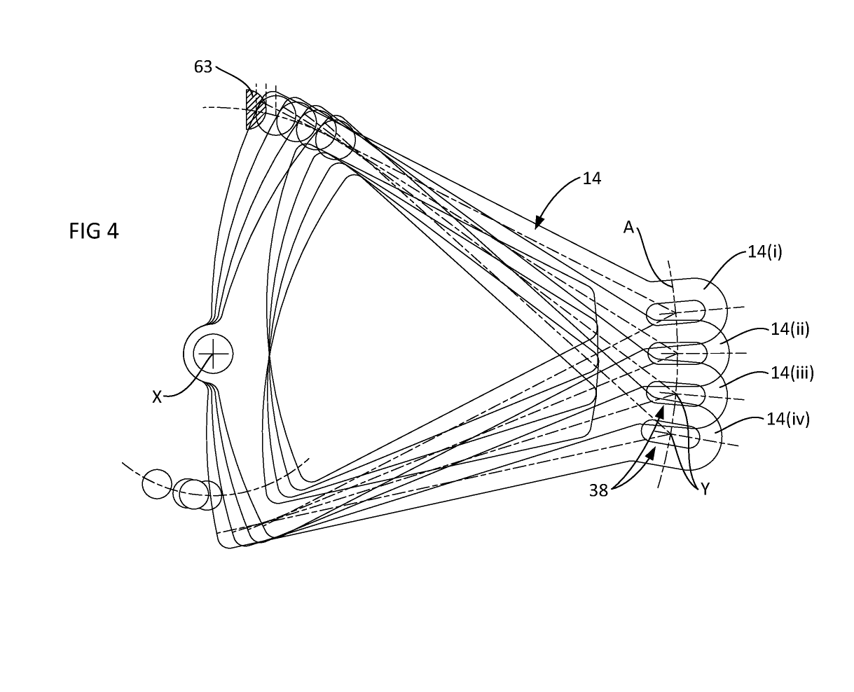

The suspension assembly 44 comprises a parallel pair of laterally spaced, substantially horizontally extending shock absorbers 46, of which one is shown in the exploded view of FIG. 2, and in longitudinal section in FIGS. 3A-C. At its trailing end, each shock absorber 46 has a connector 48 in the form of an eyelet. As can be appreciated from FIG. 1, that the connector 48 is pivotally connected by a bolt 50, having an associated washer 52, to a respective end of the transversely extending mount 38 secured on lower transverse member 36. Thus, the trailing end of each shock absorber 46 has its trailing end pivotally connected to the rear frame 14. Each shock absorber 46 extends from the rear frame 14, across the lower transverse member 26 secured to the trailing end of each lower side member of the main frame 12, to a connection between the leading end of the shock absorber 46 and the transverse bracket 28 connecting the lower side members 16 of the main frame. As can be seen more clearly in FIGS. 2 and 3A-C, each shock absorber 46 has a cylindrical housing 54 containing an hydraulically dampened arrangement 56 of a piston (not visible) and cylinder 60, with a piston rod 62 projecting from the leading end of cylinder 60. From cylinder 60, the piston rod 62 projects through an adjuster plate 64, retained in the leading end of the housing 54 by a circlip 66, to a connection, via a stub shaft extension 68, to the transverse bracket 28 of the main frame 12. The trailing end of the stub shaft

extension 68 is internally threaded for threaded engagement with external treading on the leading end of piston rod 62. The trailing end of the cylinder 60, on which the connector 48 is mounted, projects through the trailing end of the housing 54 and, as indicated, is pivotally connected via the mount 38, to the lower transverse member 36 of the rear frame 14. Each shock absorber 46 also includes a helical spring 70 (of which only respective ends are shown in FIGS. 3A-C) mounted around the arrangement 56 and contained between an annular retainer 72 fixed around the leading end of the cylinder 60 and an annular stop 74 located around the trailing end of the cylinder 60 and fixed to an annular flange 76 at the trailing end of the housing 54. The arrangement is the reverse of that usual with shock absorbers in that the shock absorbers 46 expand or contract as the rear frame 14 pivots up or down, respectively, to cause compression or expansion of the spring 70, with spring recovery dampened by the piston and cylinder arrangement 56.

As previously indicated, each shock absorber 46 has a connector 48 at its trailing end by which it is attached to the mount 38 of the rear frame 14. The leading end of each shock absorber 46 is connected to the main frame. For this, each stub shaft extension 68 projects through a respective opening 28a in an upstanding flange 28b of the bracket 28. On the trailing side of flange 28b, the stub shaft extension 68 extends through a bushing 78 and, as seen in FIGS. 3A-C, a first cup washer 80 with a fitted grommet 82, while on the leading side of flange 28b, a second fitted grommet 82a in a second cup washer 80a is provided, with the respective washers 80 and 80a and their grommets 82 and 82a firmly secured to grip flange 28b by application of a retaining nut 84 on the leading end of the stub shaft extension 68.

The shock absorbers 46 of a “Softail” type of motorcycle are positioned below the seat for the rider of the motorcycle and are substantially concealed by a cover under the transmission. In that location, the shock absorbers 46 and can be substantially concealed by a cover under the transmission, but their location enables the motorcycle, despite having rear suspension, to capture the aesthetic appearance of the downwardly and rearward tapering lines of earlier rigid models that were without rear shock absorbers.

The views of FIGS. 3A-C illustrate one of the pair of shock absorbers 46 in three different operating positions. As will be appreciated, each shock absorber 46 of the pair moves or should be adjusted in the same manner. In FIG. 3A, the shock absorber 46 is in a static droop position in which the spring 70 of the shock absorber 46 has contracted longitudinally to its equilibrium state, so that the trailing end of the rear frame 14 (and its wheel) is lowered relative to the main frame 12 and so that the seat of the motorcycle elevated. The position of FIG. 3A can be attained in the absence of the weight of a rider and other loading on the motorcycle, that is, with the unsprung mass of the suspension. Alternatively, the position of FIG. 3A can result from the loaded motorcycle passing over a large pothole. In contrast, in FIG. 3B, the shock absorber 46 has its spring 70 fully extended. In the position of FIG. 3B the trailing end of the rear frame 14 is elevated relative to the main frame to the full extent permitted by the connection between the rear frame 14 and the main frame 12, with the seat fully lowered, such as can result from the motorcycle passing over a large gutter or other obstacle. FIG. 3C shows the shock absorber 46 in an adjusted condition, attained by rotating the adjuster plate 64. This causes an annular stop member 86, threaded on piston rod 62, to move rearward to a position in which member 86 is engaged by corresponding member 88 mounted around on piston rod 62 at the leading end of cylinder 60.

The available pivotal movement of the rear frame 14 on the transverse axis “X”, under the control of the rear shock absorbers 46, is illustrated in FIG. 4 in which only the rear frame 14 is shown. Four positions 14(i) to 14(iv) are shown in FIG. 4, with pivoting of frame 14 relative to the transverse axis “X”, shown in a fixed position, so that the rear axle for a wheel mounted on the opposed axle mounts 38 traverses an arc of travel “A” centred on axis “X” Position 14(i) for frame 14 is the full bump position in which the upper transverse member 24, that connects the leading ends of upper side members 32 of frame 14, engages bump-stops 63 that are mounted on the rear surface (not shown) of transverse member 24 connecting the upper side members 18 of main frame 12. The position 14(i) assumes a 50% compression of the rubber of which bump-stops 63 are comprised, so that position 14(i) corresponds to the lowermost height for the seat of the motorcycle relative to an axis “Y” on which the rear wheel (not shown) is mountable. The position 14(iv) for frame 14 represents the other extreme of full droop, in which the motorcycle seat is at its uppermost height. In position 14(iv), the shock absorbers 46 are fully compressed, as shown in FIG. 3A, so that the stop member 86 is in its forward-most position and is engaged by the corresponding member 88 mounted on piston rod 62, at the leading end of cylinder 60. Intermediate positions 14(ii) and 14(iii) respectively show the recommended maximum lowered position and ride height position in which beneficial shock absorbing action is obtained.

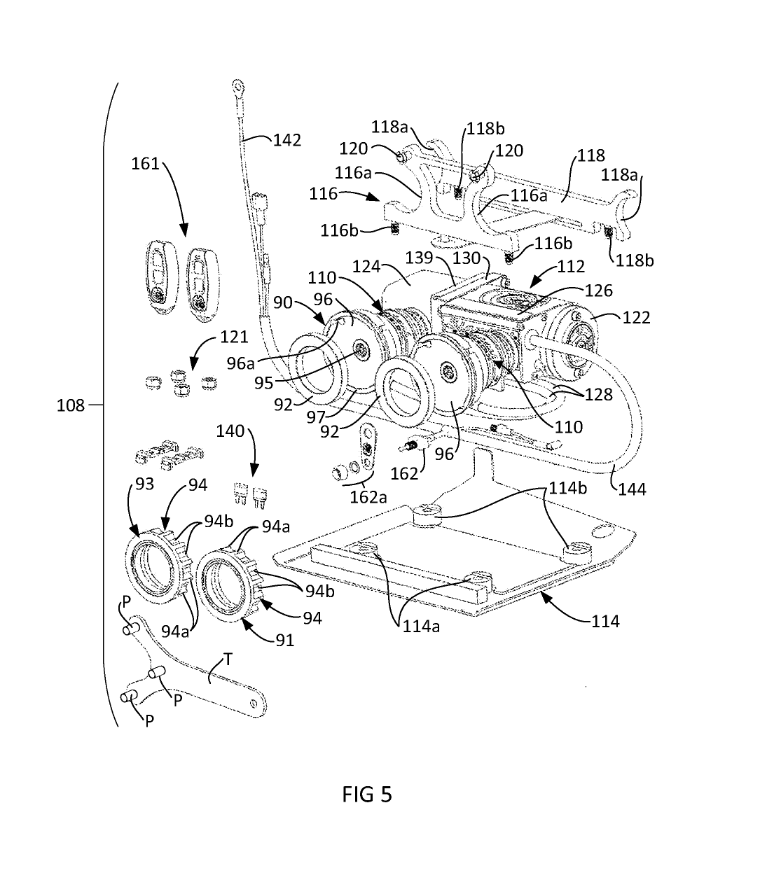

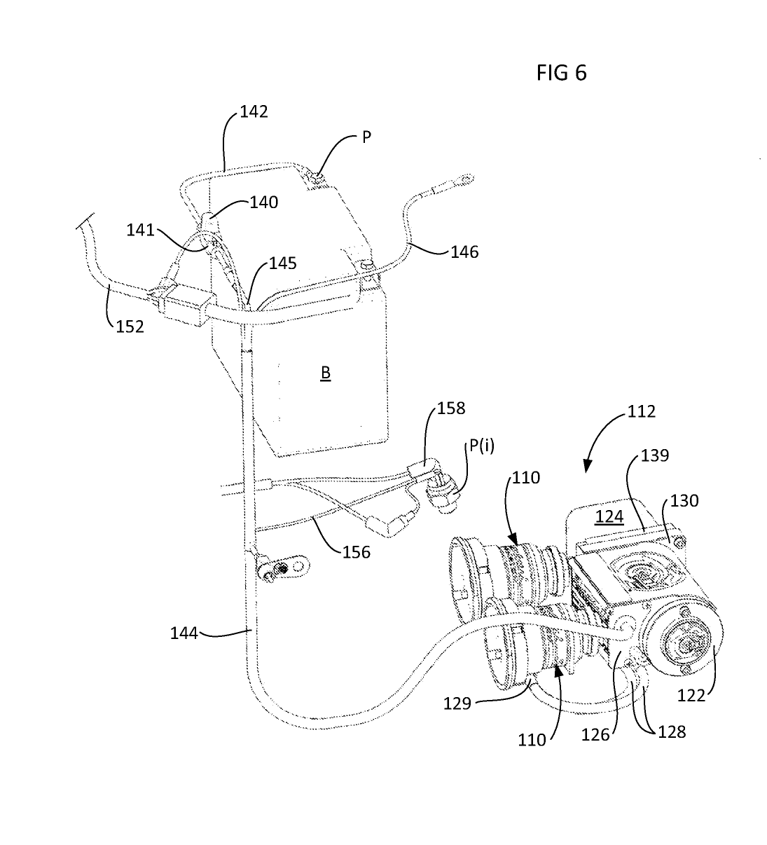

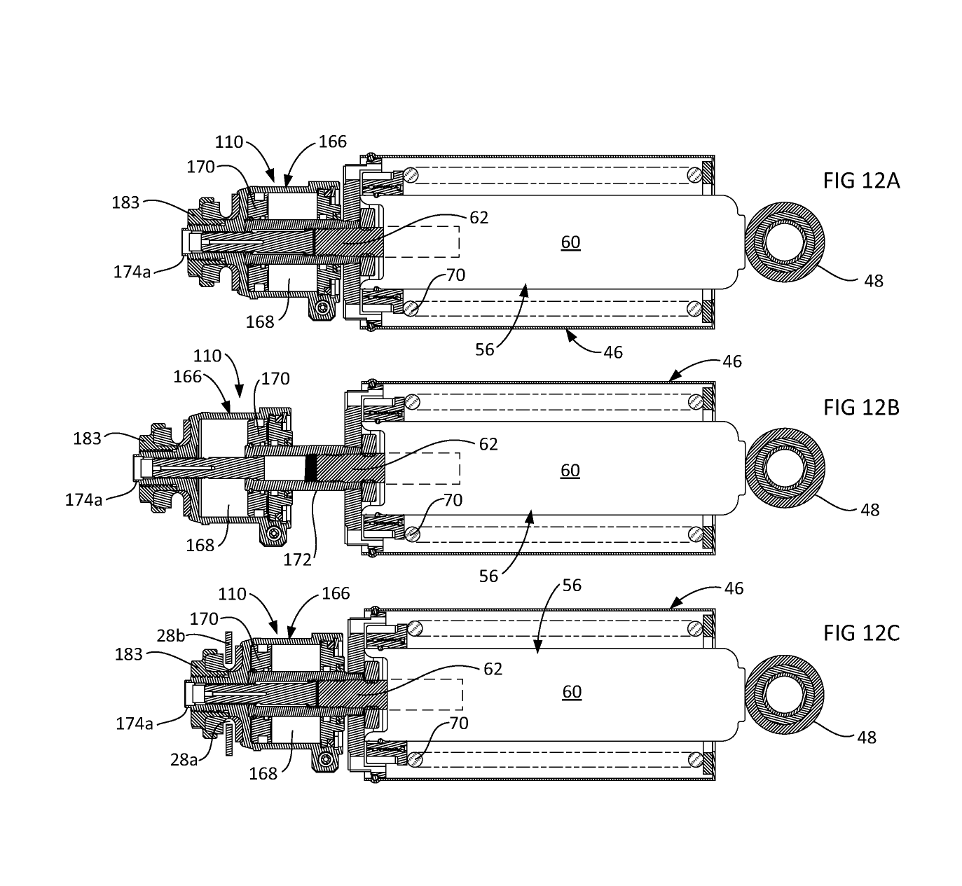

Respective exploded perspective views of components of an on-board mountable power unit system 108 of the invention are shown in FIGS. 5 and 6. The system 108 includes a parallel pair of substantially identical actuators 110, and an hydraulic power unit 112. The actuators 110 and unit 112 are shown as coupled together in the required relationship enabling the unit 112 to power the actuators 110. However, as will be apparent from later description, and as shown in FIG. 12C, a leading end of the actuator needs to be inserted through the transverse bracket 28 connecting the lower side members 16 of the main frame 12 before the coupling is made. Also, the trailing end of each actuator is shown as having fitted thereon a modified form of adjuster plate 90 that can be used instead of the standard form of adjuster plate 64 used on the “Softail” type of motorcycle. The part 90 is secured as a press fit onto the trailing end of the is used in combination with a two-part collar 91 as described later herein.

The system 108, as seen in FIG. 5, also includes an under-tray assembly 114, a rear mounting-bracket 116 and a front mounting bracket 118. The assembly 114 fits under the lower side members 16 of the main frame 12, forwardly of the transverse bracket 28 that connects those members 16. The assembly 114 supports the power unit 112, with this enabled by assembly 114 being secured to each of brackets 116 and 118 and each of members 116 and 118 engaged in relation to the lower members 16 of the main frame 12. The bracket 116 locates against the forward face of bracket 28 and has hook devices 120 that engage over the upper edge of the upright flange 28b (see FIG. 12C) of the bracket 28 through which a forward extension of each of the actuators 110 extends. The bracket 116 has arcuate sides 116a that provide clearance allowing bracket 116 to engage flange 28b between the leading ends of the actuators 110. The bracket 118 is in the form of an elongate bar having end pieces each with an arcuate end faces 118a such that, after bracket 118 is inserted at an acute angle to, and between, the lower side members 16 of the main frame 12, and then moved so as to extend transversely with respect to lower side members 16, each face 118a is adjacent a respective one of members 16 and bracket 118 is secured. Each bracket 116 and 118 has depending bolts 116b and 118b, with the bolts 116b and 118b passing through rear spacers 114a and forward spacers 114b, respectively, of under-tray 114 and each of the bolts 116a and 118a is secured below under-tray 114 by nuts 121, such as UNC Nyloc nuts.

The hydraulic power unit 112, as shown in FIGS. 5 to 7, comprises an assembly including a bi-directional pump 122, a container 124 from and to which the pump 122 is operable to pump hydraulic fluid, depending on the selected direction in which pump 122 acts, an electric motor 126 for driving the pump 122 and a respective hydraulic fluid flow line 128 by which pump 122 able to pump hydraulic fluid from one to the other of container 124 and each of actuators 110. The power unit also includes a mounting block 130 by which the pump 122, the container 124 and the motor 126 are secured in relation to each other as an operating unit. The block also functions to provide fluid communication between container 124 and a port (not show) of pump 122 and between another port (also not shown) of pump 122 and a respective connector (not shown) to which one end of each flow line 128 is coupled. The other end of each flow line 128 is coupled to a connector 129 of a respective actuator 110.

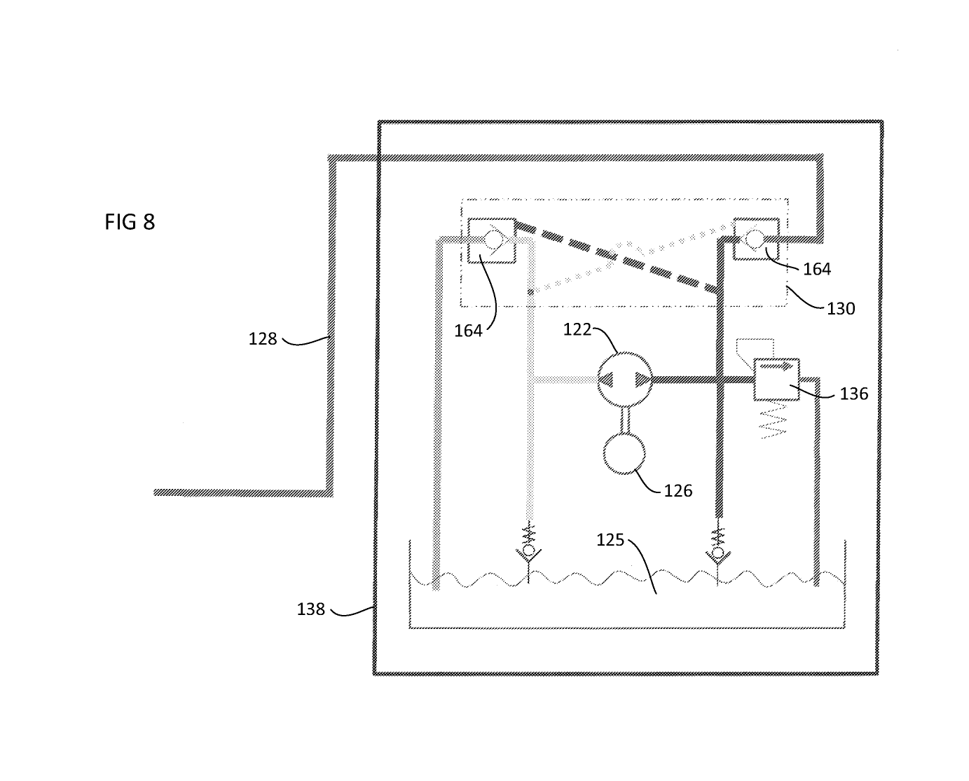

In a preferred form, the hydraulic power unit 112 has a 12V DC electric motor 126 operating on a 10 A current. The motor 126 drives pump 122 with the pump 122 preferably comprising a bi-directional gear type of pump having a pressure relief valve 136 shown in the hydraulic circuit 138 FIG. 8. In the preferred form of power unit 112, the container 124 is made of resilient synthetic plastics material and has an open side facing mounting block 130. The open side has an outer peripheral flange (not shown) by which the container is sealed against a port (not visible) defined by block 130 by a peripheral frame 139 secured to block 130. Hydraulic fluid is able to be drawn from container 124 by pump 122, with the container able to resiliently collapse as fluid is drawn from it, but the container 124 is then able to return to its as-formed shape as fluid is returned to container 124 by pump 122.

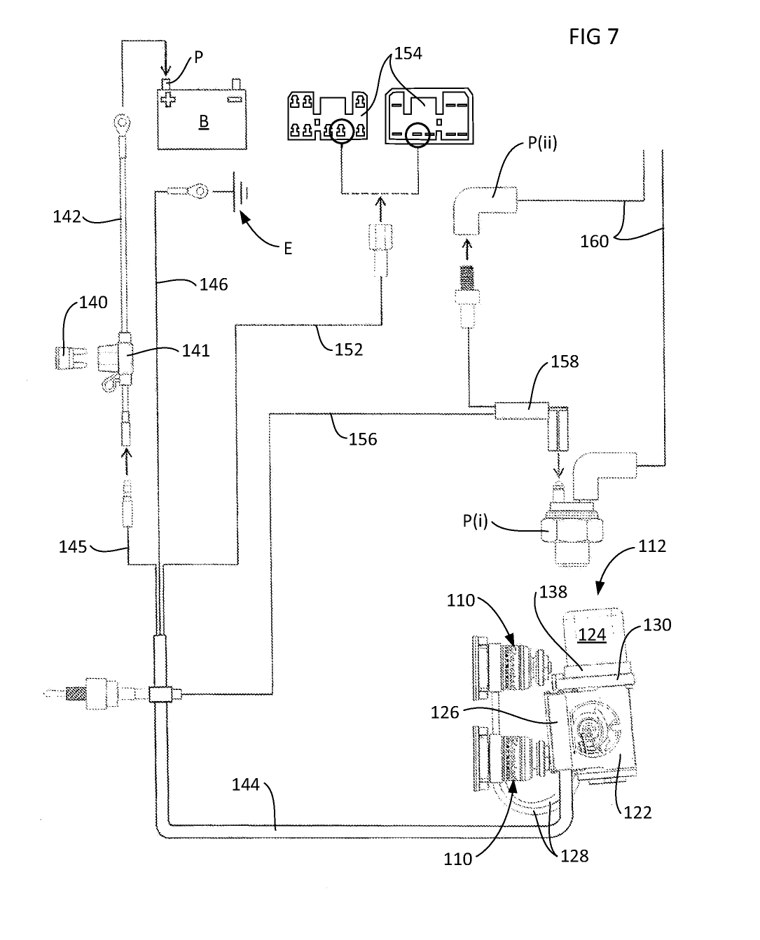

The motor 126 conveniently is able to be powered through a circuit including the battery B and the rear light harness H of the motorcycle, with the circuit including a 15A fuse 140, accommodated in fuse socket 141, and a fusible link 142, as shown in FIGS. 6 and 7. Electric conduction cable 144 provides the lead 145 that connects, via the fusible link 142, the motor 126 to the positive terminal P of the 12V battery B of the motorcycle, and lead 146 that connect to the earth terminal E of the motorcycle, while electric lead 152 connects the motor 126 to a harness plug 154 of the motorcycle, such as to the rear lamp harness. Also, a lead 156 from the motor 126 passes to a connector 158 for linking to plugs P(i) and P(ii) of the neutral signal switch harness 160 of the motorcycle.

As depicted in FIG. 6, the electrical circuitry is provided with a remote control key fob 161 (of which a spare also is shown) that enables remote wireless actuation of motorcycle ride height adjustment, via a receiver (not shown) incorporated in the block 130. Also, cable 144 is provided with an on/off switch 162, such as a toggle switch mountable by fittings 162a, provides a back-up function by which motorcycle ride height is adjustable in the event that the key fob 161 is lost, damaged or has a flat battery.

As shown in FIG. 8, the alternate hydraulic fluid flow directions enabled by pump 122 are accommodated in block 130, in relation to pump 122 and motor 126, by an hydraulic circuit 163 containing pump 122 and having a double control system in the form of a respective piloted check valve 164 for each fluid flow direction. FIG. 8 shows only a single hydraulic fluid flow line 128, but this either is duplicated to enable fluid flow to and from each actuator 110, or the one line 128 leads to a splitter for dividing the fluid flow to and from each actuator 110.

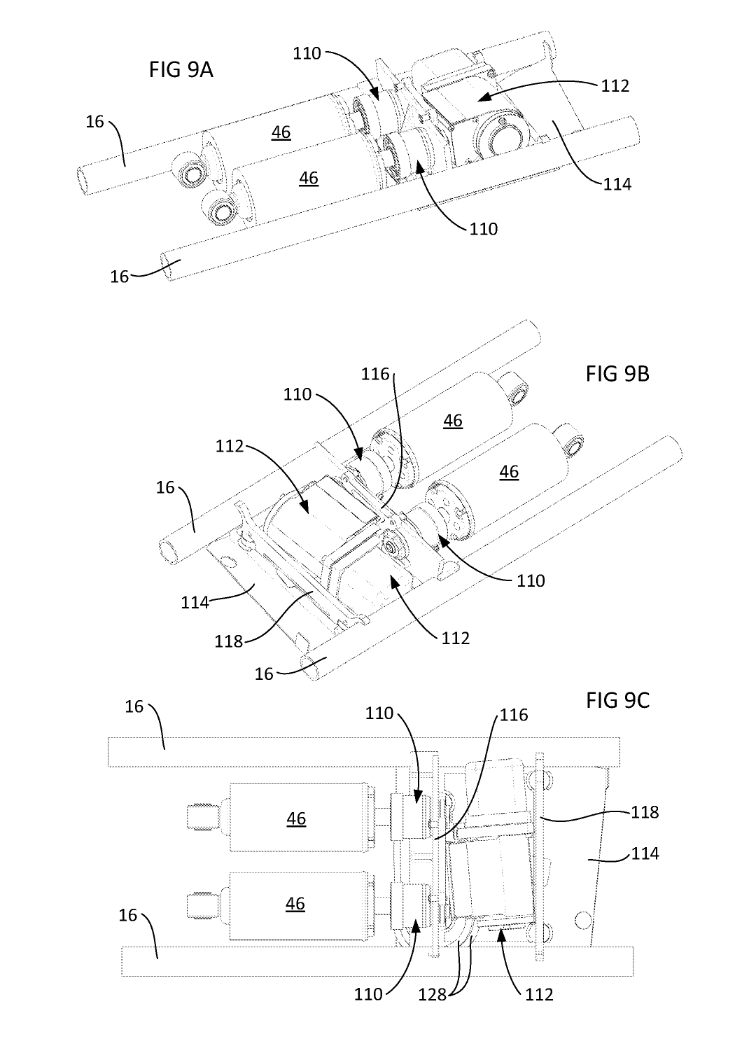

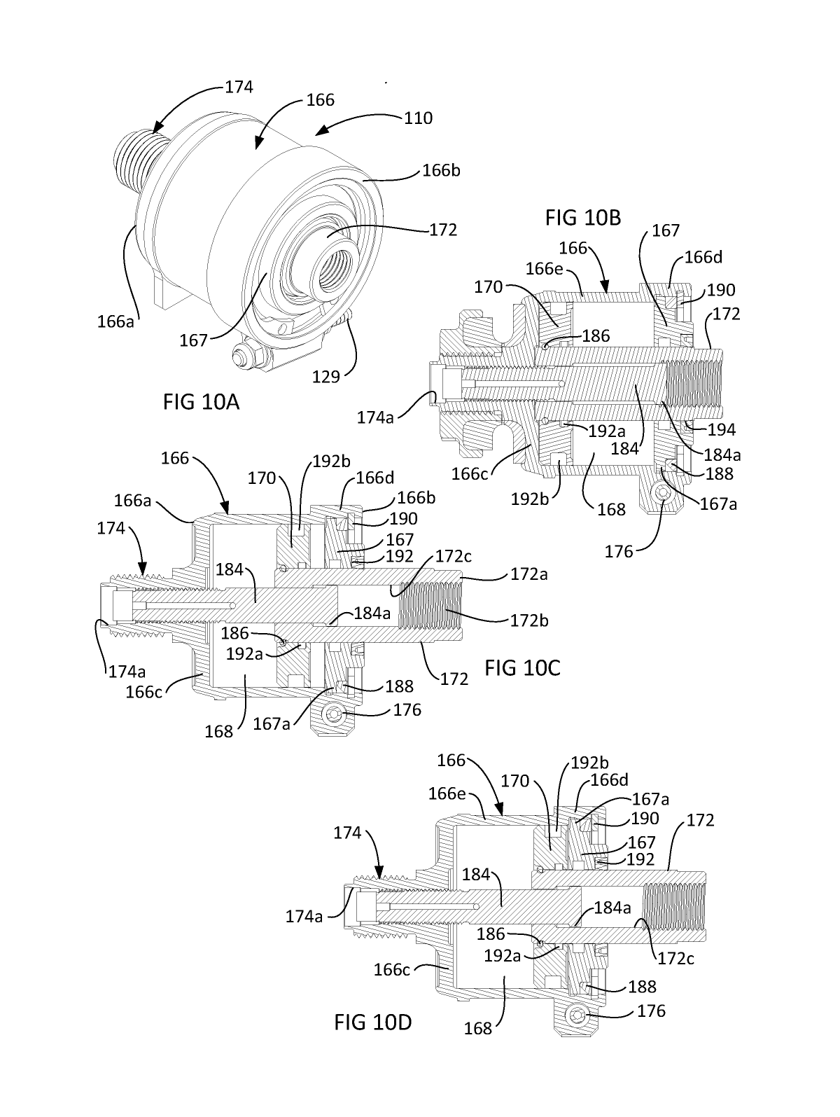

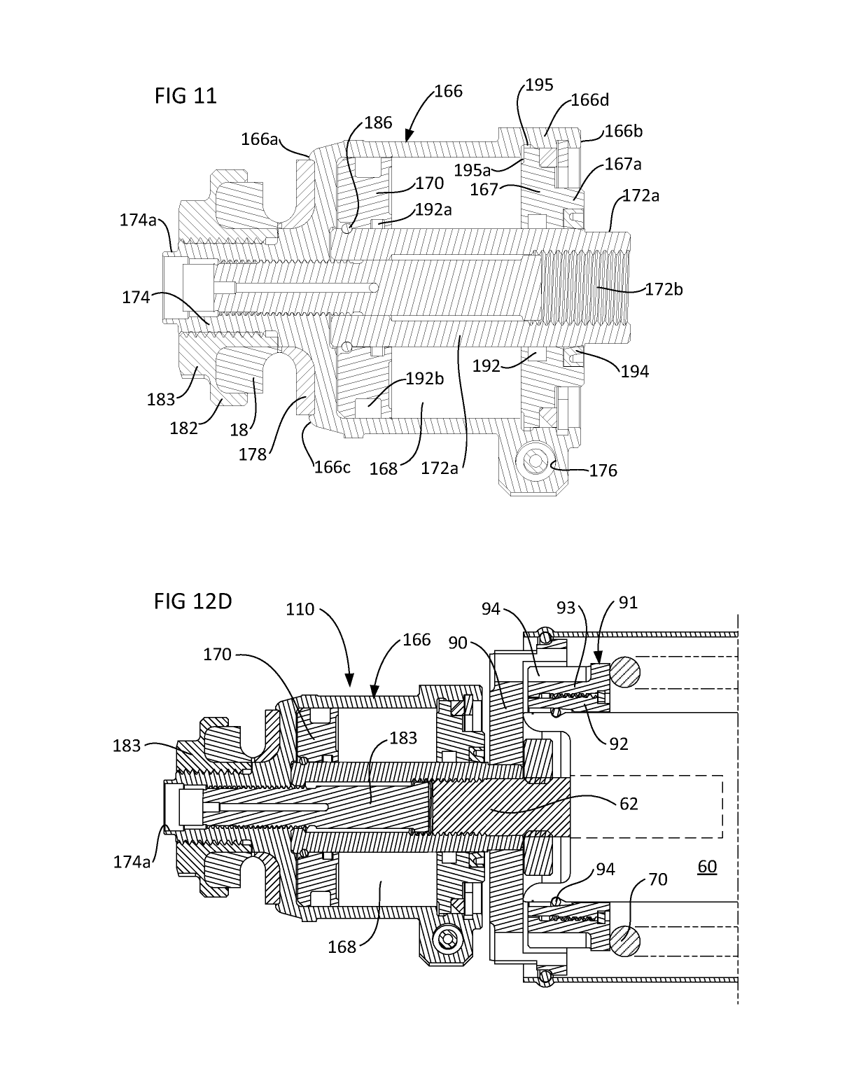

As shown in FIGS. 9A-C, 10A-D, and 12A-D, each hydraulic actuator 110 of the pair is adapted to be mounted on the forward end of the rod 62 of a piston and cylinder arrangement 56 of a respective shock absorber 46 of the rear suspension assembly of the “Softail” type of motorcycle, after removal of the stub shaft extension 68 initially provided on each rod 62. Each of the actuators 110 has a housing 166 that has a forward or leading end 166a and a trailing end 166b. The housing 166 is of annular cross-section between the ends 166a and 166b, while end 166a is defined by an annular end wall 166c and the trailing end is open but provided with an annular end plate 167. The housing 166 defines a chamber 168 that is closed by end plate 167. The chamber 168 contains a piston 170 movable between the ends 166a, 166b of the housing 166. The piston 170 has an elongate piston-rod 172 of the actuator 110 that projects from the trailing end 166b of the housing 166, through the end plate 167. The piston-rod 172 has a trailing end 172a adapted for engagement with the forward end of the rod 62 of the piston and cylinder arrangement 56 of the respective shock absorber 46 of the motorcycle. The trailing end 172a of the piston-rod 172 defines an internally threaded bore 172b enabling screw-threaded engagement with the rod 62 of the shock absorber 46 in substantially the same manner as the removed stub shaft extension 68 that had been engaged, or was engageable, with that rod 62. The leading end 166a of the housing 166 has an elongate forward extension 174 that extends from and forwardly beyond the end wall 166c, with a leading end 174a of the forward extension 174 adapted for engagement with the transverse bracket 28 by which the lower side members 16 of the main frame 12 of the motorcycle are connected. The leading end 174a of the forward extension 174 is engageable with that transverse bracket 28 in substantially the same manner as the removed stub shaft extension 68 had been engaged, or was engageable, with that transverse bracket 28. Thus, each actuator 110 is able to connect the rod 62 of the piston and cylinder arrangement 56 to the transverse bracket 28 of the main frame 12, with this connection similar to that otherwise provided by the stub shaft extensions 68 of the shock absorbers 46 in the usual mounting arrangement for the rear shock absorbers 46 of a “Softail” type of motorcycle. However, each of the shock absorbers 46 need first to be removed from their mountings on a “Softail” type of motorcycle and, after the stub shaft extensions 68 are removed, each of the actuators 110 is mounted on a respective shock absorber 46 by the piston-rod 172 of the actuator 110 being threaded onto the rod 62 of the piston and cylinder arrangement 56 of the shock absorber 46, and the shock absorbers 46 then are re-installed in an assembly including the actuators 110.

The housing 166 of each actuator 110 has a port 176 through which pressurised hydraulic fluid can be charged to or discharged from the chamber 168 at a trailing side of the piston 170. Hydraulic fluid can be pumped into or from the chamber 168 to drive the piston 170 to or towards the leading or trailing end of the chamber 168, respectively, to attain a desired position for the piston 170 in the chamber 168. Thus, with the power unit system 108 installed on a “Softail” type of motorcycle, the rod 68 of the piston of the piston and cylinder arrangement 56 of the shock absorber 46 of the motorcycle can be drawn to a required position. Accordingly, the actuators 110 are operable to adjust the shock absorbers 46 of a “Softail” type of motorcycle to attain a required ride height, with the ride height being able to be varied, as required by a rider of the motorcycle, over a range preferably limited only be the physical constraints inherent in the hinged connection between the main and rear frames of such motorcycles. The chamber 168 of housing 166 of each actuator 110 has a size enabling the piston 170 to move between trailing and leading extremes that do not limit that range.

The stroke of the piston 170 of each of the actuators 110, for the typical stroke of the piston and cylinder of the shock absorber for a Harley Davidson “Softail” motorcycle, may be at least 20 mm, preferably at least 21 mm, such as 22 mm. The chamber 168 of the housing 166 in which the piston 170 is movable may have a diameter that is greater the stroke of the piston, with a suitable diameter ranging up to about 45 mm. However, the diameter preferably ranges from about 38 mm to about 42 mm. As will be appreciated, the actuators 110 are very small relative to the shock absorbers 46, as realistically illustrated in FIGS. 9A-C and 12A-D. The actuators also are small in relation to alternative arrangements proposed for the “Softail” type of motorcycles the usually entail complete replacement of the rear suspension of those motorcycles.

The forward extension 174 of each actuator 110 is short relative to the removed stub shaft extension 68, due to the limited available space to be occupied by the actuator housing 166 when the power unit system 108 is installed on a motorcycle. In contrast to the Harley Davidson arrangement utilising stub shaft extensions 68, the arrangement of the invention saves some space by utilising a first grommet 178 provided around the forward extension 174 of each actuator 110, directly against the outer surface of the end wall 166c at the leading end of the housing 166. The forward extension 174 then is able to pass through the opening 28a in the upright flange 28b, to enable the flange 28b to be gripped closely adjacent to the wall 166c between that grommet 178 and a second grommet 180 housed in a cup washer 182 having a second grommet 178a and provision of a retaining nut 182 threaded onto the leading end of the forward extension 174.

In the actuators 110 the piston-rod 172 and the forward extension 174 are co-axial with each other and with the chamber 168 in which the piston 170 is movable, with the chamber 168 of cylindrical form. The piston-rod 172 is in the form of an annular sleeve having a bore 172c throughout the length of the sleeve. As indicated above, the trailing end of the piston-rod 172 is internally screw threaded for engagement with the leading end of the rod of the shock absorber of the motor cycle although, with a sleeve form of piston-rod 172, the internal threading need only be at the trailing end 172b of the bore 172c. The actuator 110 includes a shaft 184 that projects from the wall 166c at the leading end of the housing 166, co-axially within the chamber 168 and into the bore 172c of the piston-rod 172. Over a main part of its length, the shaft 184 is a neat sliding fit in at least a leading end part of the bore 172c. The shaft 184 has a slightly larger trailing end part 184a that is a neat sliding fit in a main part of the length of the bore 172c of the piston rod 172, such that at a rearward limit to the movement of the piston 170 in the housing 166, a forwardly facing annular surface of the shaft 184 within the sleeve comprising piston-rod 172 bears against a rearward facing annular surface adjacent to the leading end of the bore 172c.

In addition to each actuator 110 having the shaft 184, the forward extension 174 also is an annular sleeve defining a bore 174a extending throughout its length. Also, the piston 170 is of an annular form that fits neatly on the leading end of the piston-rod 172 where it is secured by a round wire snap ring 186 captured in opposed grooves, around the piston-rod 172 and in the inner periphery of the piston 170. Also, the shaft 184 extends from within the bore 174a of the forward extension 174 and is retained within bore 174a, by screw-threaded engagement, in the bore 174a, between the forward extension 174 and the shaft 184. The shaft 184 has a leading end that is at, adjacent or close to the leading end of the forward extension 174, such as to be accessible from the leading end of the forward extension. The arrangement may be such that, by access to bore 174a at that leading end, the shaft 184 is longitudinally adjustable in the forward extension 174 to vary, by a limited amount, the extent to which the shaft 184 extends into the chamber 168. Thus, the axial location at which the oppositely facing annular surfaces of the shaft 184 and the piston-rod 172 are able to abut and, hence, the rearward limit to the movement of the piston 170 in the housing 166, can be adjusted to a limited amount. However, access at the leading end of the forward extension 174 may be, and preferably is, precluded by a safety seal (not shown).

The forward extension 174 and the housing 166 of each actuator 110, including the end wall 166c, preferably comprise a single-piece, unitary construction produced by casting or machining of a suitable high strength metal, such as a high tensile steel that preferably is nitrided. The chamber 168 is defined by the wall 166c at the leading end of the housing 166, a peripheral wall 166c of housing 166 and the annular end plate 167 that is fitted at the trailing end of the housing 166 and through which the piston-rod 172 extends. A relatively short trailing end section 166d of the peripheral wall accommodates the end plate 167. The end section 166d has a slightly larger internal diameter than the chamber 168 along which the piston 170 is movable, to provide an internal shoulder of the housing against which a peripheral flange 167a of the end plate 167 locates. A resilient “O” ring 188 is forced against the trailing side of the peripheral flange 167a by a retaining circlip 190, to provide a static seal between the housing 166 and the periphery of the end plate 167. A dynamic seal 192 is provided between the piston-rod 172 and an inner peripheral surface of the end plate 167 by an “O” ring seal located in an annular groove in the inner peripheral surface, with the seal preferably an X-section ring. A similar dynamic seal 192a is provided between the inner periphery of the piston 170 and the piston-rod 172, adjacent to the snap ring 186 that retains the piston 170 on the piston-rod 172, while a further similar dynamic seal 192b is provided between the outer periphery of the piston 170 and the housing 166. The static seal, and each dynamic seal, preferably is formed of a suitable grade of a synthetic rubber, for example a Nitrile rubber such as Nitrile 70 durometer rubber. Also, the trailing face the end plate 167 has an annular flange 167b, concentric with and closely adjacent to the piston-rod 172, and a wiper ring 194 is provided between the flange and the piston-rod.

The respective port 176 through which pressurised hydraulic fluid can be charged to or discharged from the chamber 168 in each housing 166 of each actuator 110 communicates with an annular groove 195 formed around the inner surface of the trailing end section 166d of the housing on the leading side of the dynamic seal 188 provided against the flange of the end plate. From that groove, the hydraulic fluid is able to pass to the chamber via a number of radial grooves 195a in the internal shoulder of the housing or in an outer margin of the leading face of the end plate.

With the actuators 110 installed on a “Softail” type of motorcycle, access to the adjuster plate to enable the pre-loading of the shock absorbers to be adjusted can be restricted, as detailed above. As a consequence, it can be beneficial to adopt a modified form of adjuster plate arrangement such as the two-part form shown in FIG. 5, in part in FIG. 6, and also in FIGS. 12A-D. With the modified arrangement, a modified adjuster plate 90 for each shock absorber replaces the original equipment adjuster plate and is adapted to be used in combination with an internal collar device 91 that is adapted to be fitted around the leading end of the cylinder 60 of the piston and cylinder arrangement 56 of the shock absorber 46. The modified adjuster plate 90 has a central bore by which it is secured as a press fit on the trailing end of the piston-rod 172 of the actuator and then is fitted in the leading end of the shock absorber housing 54 in a similar manner to the originally supplied, replaced adjuster plate. The collar device 91 fits around the cylinder 60, preferably by being received from the trailing end of the piston and cylinder arrangement 56, and secured on the leading end of the cylinder 60. The collar device 91 has an inner part 92 and outer part 93, with the parts 92 and 93 concentric and coupled together by a screw-threaded engagement so that, with the inner part 92 axially fixed on the cylinder 60, the outer part 93 is able to rotate and move axially relative to the inner part 92. The inner part 92 is releasably fixed on the cylinder 60 by the part 92 defining a bore through which the cylinder 60 is received, with the bore tapered so as to as to have a slightly frusto-conical form, with half angle of about 1 or 2 degrees, that increases slightly in diameter towards the leading end. The inner part 92 can be fixed on the cylinder by being forced axially over a wire snap ring 94 located in a peripheral groove in the outer surface of the cylinder 60 so the tapered bore surface bears against and compresses the snap ring 94 into the groove. With the inner part 92 fixed on the leading end of the cylinder 60 of the piston and cylinder arrangement 56 of a shock absorber 46, the outer part 93 is able to rotate on the inner part 92 so and move axially in one of opposite axial directions, depending on the direction of the rotation.

With the arrangement of the modified adjuster plate 90 and the two-part collar device 91, the outer part 93 of the collar device replaces the annular retainer 86 of the original equipment shock absorber 46. As with that retainer 86, the collar device 91 enables variation in the degree of pre-load applied to the spring 70 of the shock absorber 46, with the pre-load varied by rotation and axial adjustment of the outer part 93 of the collar device 91 relative to the inner part 92. As shown most clearly in FIG. 12D, the outer part 93 has an annular trailing end-face against which a leading end of spring 70 bears resiliently. Rotation of outer part 93, to vary the pre-loading of spring 70, is able to be achieved by inserting the of prongs P of a suitable tool T through selected openings spaced around the outer periphery of the modified adjuster plate 90, and engaging the prongs P with formations of the outer part 93 of the collar device 91. The modified adjuster plate 90 may, for example, have three, four or even more uniformly spaced openings through at least two selected openings respective prongs P are able to be inserted to engage the formations of the outer part 93 and to enable the tool T to apply required torque for rotating the modified adjuster plate 90 and the outer part 93 of the collar device 91. To enable this, the outer part 93 has an undulating periphery forming a circumferential array of longitudinally extending openings or keyways 94 in selected ones of which the prongs P are locatable for rotation of the outer part 93 by the tool. In the arrangement shown, the openings or keyways 94 are defined by the outer periphery of the outer part 93 and comprise a circumferential array of alternating ribs 94a and grooves 94b, with the grooves being U-shaped in cross-section.

The on-board power unit of the invention enables installation on a “Softail” type of motorcycle in a manner that is fully integrated into the “Softail” look, and so not detracting from the visual aesthetic of the motorcycle and its resemblance to a “Hardtail”. However, when installed, the unit enables the motorcycle to be adjusted from standard height, to over 2.5 inches down, with the adjustment taking only a few seconds. The unit is able to provide a steady, controlled and linear operation to raise or lower ride height, and is able to avoid leaking down from a chosen height, even after long rides or extended storage periods. It enables adjustment for owners who want to “Slam” their rides; that is, to adjust to an extent resulting in a rigid frame ride by cancelling the action of the shock absorbers. Also, the unit retains the benefit of a fully hydraulic suspension that attaches to the OEM springs and shockers, using rather than scrapping them, and avoiding recourse to the use of airbags. The unit facilitates use of precision engineering and use of aircraft quality billet aluminium and steel alloys. Additionally, when including the modified adjuster plate with the two-part collar device, the unit can be readily adjusted to firm up the ride for better handling, to adjust when a pillion passenger is to be carried, or to offset “spring sag”.

1. An on-board mountable power unit for ride-height adjustment of a “Softail” type of motorcycle, wherein the unit includes a pair of hydraulic actuators, each adapted to be mounted on the forward end of the rod of a piston and cylinder arrangement of a respective shock absorber of the rear suspension assembly of the “Softail” type of motorcycle, after removal of the stub shaft extension of each rod; each of the actuators is an hydraulic actuator ram that has a housing with longitudinally spaced forward and trailing ends and that defines a chamber containing a piston movable between those ends and the piston has an elongate piston-rod that projects through an end plate at the trailing end of the housing and has a trailing end adapted for engagement with the forward end of the rod of the piston and cylinder arrangement of the respective shock absorber; wherein, at the forward end, the housing has a forward extension that has a forward end of the extension engageable with the transverse bracket connecting the lower side members of the main frame of the motorcycle; and wherein each actuator is able to connect the rod of the piston and cylinder arrangement of a respective shock absorber to the transverse bracket, with this connection similar to that otherwise provided by the stub shaft extensions of the shock absorbers in the usual mounting arrangement for the rear shock absorbers of a “Softail” type of motorcycle.

2. The power unit of claim 1, wherein the housing of each actuator has a port through which pressurised hydraulic fluid can be charged to the chamber of the housing at a trailing side of the piston, whereby hydraulic fluid can be pumped into or from the chamber to drive the piston to or towards the leading or trailing end of the chamber to attain a desired position for the piston in the chamber so that, with the power unit installed on a “Softail” type of motorcycle, the rod of the piston of the piston and cylinder arrangement of the shock absorber of the motorcycle can be drawn to a required position to attain a required ride height.

3. The power unit of claim 1, wherein the stroke of the piston of each of the actuators, for the typical stroke of the piston and cylinder of the shock absorber for a Harley Davidson “Softail” motorcycle, is at least 20 mm, preferably at least 21 mm, such as 22 mm, and the chamber of the housing in which the piston is movable has a diameter that is greater than the stroke of the piston, with a suitable diameter ranging up to about 45 mm, such as from about 38 mm to about 42 mm.

4. The power unit of claim 1, wherein the axial length of the housing between the leading and trailing ends and the stroke of each piston within the housing are such that, with the actuators installed on a “Softail” type of motorcycle, the actuators are able to position the shock absorber at or between first and second extreme positions spaced by the stroke of the actuator pistons, by appropriate flow of hydraulic fluid to or from the chamber of each actuator to adjust the respective piston and, hence,

5. The power unit of claim 4, wherein in the first of the extreme positions the adjuster plate at the leading end of the shock absorber housing is closely adjacent to the end plate at the trailing end of the housing of the actuator, while in the second position the adjuster plate and the end plate are axially spaced by substantially the stroke of the actuator pistons.

6. The power unit of claim 5, wherein in the first position the leading end of the piston rod of each of the shock absorbers is received within the inner periphery of the end plate of the respective actuator housing, while the trailing end of the piston-rod of each actuator remains within the inner periphery of the adjuster plate of the respective shock absorber throughout positioning of the shock absorbers

7. The power unit of claim 1. Wherein the forward extension of each actuator of the power unit of the invention is short relative to the removed stub shaft extension, due to space to be occupied by the actuator housing when the power unit is installed in a motorcycle grommet and a retaining nut threaded onto the stub shaft extension, with a first grommet provided on the forward extension of each actuator, against the outer surface of the leading end of the housing, with the forward extension then passing through the upright flange and being retained by a cup washer with a second grommet, and a retaining nut threaded onto the leading end of the forward extension.

8. The power unit of claim 1, wherein in each of the actuators the piston-rod and the forward extension preferably are co-axial with each other and with the chamber in which the piston is movable, with the chamber of cylindrical form, with the piston-rod comprising an annular sleeve having a bore throughout the length of the sleeve and with the trailing end of the piston-rod internally screw threaded for engagement with the leading end of the rod of the shock absorber of the motorcycle.

9. The power unit of claim 8, wherein each actuator includes a shaft that projects from the wall at the leading end of the housing, co-axially within the chamber and into the bore of the piston-rod sleeve, and the shaft, over a main part of its length, is a neat sliding fit in at least a leading end part of the bore of the piston-rod sleeve.

10. The power unit of claim 9, wherein the shaft has a slightly larger trailing end part that is a neat sliding fit in a main part of the length of the bore of the piston-rod sleeve, such that at a rearward limit to the movement of the piston in the housing, a forwardly facing annular surface of the shaft within the sleeve bears against a rearward facing annular surface of the sleeve.

11. The power unit of claim 10, wherein the forward extension also is annular sleeve having a bore extending throughout the length of the forward extension, and the shaft extends from within the bore of the forward extension in which it is retained, such as by screw-threaded engagement in the bore, with the shaft having a leading end that is at, adjacent to or close to the leading end of the forward extension, such as to be accessible from the leading end of the forward extension whereby the shaft is longitudinally adjustable in the forward extension to vary, by a limited amount, the extent to which the shaft extends into the chamber.

12. The power unit of claim 1, wherein the forward extension and the housing of the actuator, including the end wall at the leading end comprise a single-piece, unitary construction produced by casting or machining of a suitable high strength metal, such as a high tensile steel.

13. The power unit of claim 1, wherein the chamber is defined by the wall at the leading end of the housing, a peripheral wall of the housing and the annular end plate, with the end plate fitted at the trailing end of the housing and the piston-rod extending through the end plate, and wherein a relatively short trailing end section of the peripheral wall accommodates the end plate, the end section having a slightly larger internal diameter than the chamber along which the piston is movable, to provide an internal shoulder of the housing against which a peripheral flange of the end wall locates and a resilient “O” ring is forced against the trailing side of the peripheral flange by a retaining circlip to provide a static seal between the housing and the periphery of the end wall.

14. The power unit of claim 13, wherein the respective port through which pressurised hydraulic fluid can be charged to the housing of each actuator communicates with an annular groove formed around the inner surface of the trailing end section of the housing on the leading side of the dynamic seal provided against the flange of the end plate, with the hydraulic fluid able to pass to the chamber via a number of radial grooves in the internal shoulder of the housing or in an outer margin of the leading face of the end plate.

15. The power unit of claim 1, further including an hydraulic power unit operable to supply pressurised hydraulic fluid to, or to enable hydraulic fluid to discharge from, the chamber of each actuator to enable adjustment of the ride height of a “Softail” type of motorcycle on which the power unit is mounted.

16. The power of claim 15, wherein the hydraulic unit includes a reservoir containing a sufficient volume of hydraulic fluid, a pump for supplying hydraulic fluid from the reservoir to the chamber of each actuator via a respective hydraulic fluid flow line and enabling a return flow of fluid to the reservoir, and an electric motor operable for driving the pump.

17. The power unit of claim 16, further including ancillary circuitry connectable to the electric system of the motorcycle for operating and controlling the electric motor according to the requirements of the motorcycle rider.

18. The power unit of claim 16, wherein the reservoir, pump, hydraulic fluid flow line and electric motor of the power unit are assembled into a compact unit able to be installed and secured between the lower side members of the main frame, adjacent to the leading side of the transverse bracket that connects those side members, with the hydraulic unit housed in a frame structure mountable in relation to the lower side members of the main frame.

19. The power unit of claim 18, wherein the hydraulic unit is secured by being housed in a frame structure having an under-tray assembly, designed to be positioned under the lower side members of the main frame, and a mounting bracket assembly able to be located between those side members and secured to the under-tray assembly.

20. The power unit of claim 19, wherein the bracket assembly consists of a leading mounting bracket and a trailing mounting bracket each of which can be connected to the under-tray such as by screw-threaded bolts, with the trailing mounting bracket shaped to fit against the leading surface of the transverse bracket that connects between those lower side members, with each end of the trailing bracket shaped to fit around the retaining nut threaded onto the leading end of the forward extension of each actuator, and the trailing bracket adapted to be held in such position by having hooks that engage over the upper edge of the upright flange of the transverse bracket, and the leading mounting bracket is spaced forwardly from the trailing mounting bracket and held by having respective end portions each engageable around a respective lower side member.

21. The power unit of claim 15, wherein the electric motor is a 12 volt DC motor, operable on a supply current of about 10 amps, and the pump comprises a bi-directional, gear type of pressure pump provided with a pressure relief valve.

22. The power unit of claim 15, wherein the reservoir defines a chamber in direct communication with an intake port of the pump and is in the form of a resilient, synthetic rubber housing having a mouth bordered by a peripheral out-turned flange by which the housing can be clamped against a mounting block in relation to which the motor and pump also are secured.

23. The power unit of claim 1, further including a modified adjuster plate for each shock absorber, to replace the original equipment adjuster plate, and adapted to be used in combination with an internal collar device that is adapted to be fitted around the leading end of the cylinder of the piston and cylinder arrangement of the shock absorber; and wherein the collar device has inner and outer concentric parts that are coupled together by a screw-threaded engagement so that, with the inner part axially fixed on the cylinder, the outer part is able to rotate and move axially relative to the inner part.

24. The power unit of claim 23, wherein the inner part is adapted to be releasably fixed on the cylinder by the inner part having a bore through which the cylinder is received, with the bore tapered so as to as to have a slightly frusto-conical form, with half angle of about 1 or 2 degrees, that increases slightly in diameter towards the leading end, whereby the inner part can be fixed on the cylinder by being forced axially over a wire snap ring located in a peripheral groove in the outer surface of the cylinder so the tapered bore surface bears against and compresses the snap ring into the groove

25. The power unit of claim 23, wherein the collar device enables variation in the degree of pre-load applied to the spring of the shock absorber, with the pre-load varied by rotation and axial adjustment of the outer part of the collar device relative to the inner part.

26. The power unit of claim 25, wherein rotation of the outer part of the collar device is able to be achieved by inserting the of prongs of a suitable tool through selected openings spaced around the outer periphery of the modified adjuster plate, and engaging the prongs with formations of the outer part of the collar device.

27. The power unit of claim 26, wherein the modified adjuster plate has at least three uniformly spaced openings through at least two selected openings respective prongs are able to be inserted to enable the tool to apply required torque for rotating the modified adjuster plate and the outer part of the collar device, with the outer part having a circumferential array of longitudinally extending openings or keyways in selected ones of which the prongs are locatable for rotation of the outer part by the tool.

28. The power unit of claim 27, wherein the openings or keyways are defined by the outer periphery of the outer part being defined by a circumferential array of alternating ribs and grooves, with the grooves being U-shaped in cross-section.
